(19) United States
(12) Patent Application Publication
(10) Pub. No.: US 2004/0075998 A1
(43) Pub. Date: Apr. 22, 2004

(54) Advertising-effect display pen structure

(76) Inventor: Chih-Tsung Su, Shinjuang City (TW)

Correspondence Address: Chih-Tsung Su, P.O. Box No.6-57, Chung-Ho, Taipei, 235, TW

(21) Appl. No.: 10/323,787

(22) Filed: Dec. 20, 2002

(30) Foreign Application Priority Data
Oct. 17, 2002 (TW) 091216528

(51) Int. Cl. B43K 29/10

(52) U.S. Cl. 362/118; 362/109; 362/205; 362/206

(57) ABSTRACT

An advertising-effect display pen consists essentially of a top penholder, a bottom penholder, and a conjoint part, wherein a push bottom and a display illuminated mechanism are installedinside the top penholder having at least a battery, a spring, a circuit board, and at least a LED; the push button controling the circuit board enables the LED illuminated. The bottom penholder connects with the top penholder by the conjoint part, followed by removing at least a part of a layer material coated on the bottom penholder, the light emits towards the bottom penholder and the blank part being removed the material displays the emission of the light to obtain certain advertising effect.

### BACKGROUND OF THE INVENTION

1) Filed of the Invention

The present invention relates to a display pen structure, more particularly to an advertising-effect display pen structure.

2) Description of the Prior Art

Pens are handy necessities in people's daily lives and can not do without. In terms of development, the varieties and modes of pens have been multiplized in order to satisfy people of different ages, preferences, and classes.

Following by the advacement in technologies, the application of a LED (Light Emitting Diode) has been popular. The LED is made by compoments of solid-state semiconductors, which main function is to give light and display. Having a different lighting theory and construction from a conventional fungsten filament bulb, the LED has a minimum power consumption, an excellent visibility, and many colors to choose from for being compact in bulk, withstanding blunders, allowing to make mass production, which is able to be manufactured as a tiny component or a huge array component for meeting application needs. The LED can be found somewhere from advertisements, traffic lights, to all kinds of lamps and light components.

However, referring to FIG. 1 and FIG. 2, a conventional publicizing-effect pen 10 as shown, which is a common writing pen 10 with printed characters or symbols 12 on a penholder 18 or a penpoint 20 having both advertising-effect or publicizing-effect for a low cost. Although manufacturers have several different applications in combining the LED and the pen such as callin-display pens and illuminated pens, but the combination of an advertising-effect or publicized-effect pen and the LED has not been seen so far.

### SUMMARY OF THE INVENTION

The primary objective of the present invention is to provide an advertising-effect display pen structure characterized the effect of a lighting display with a multi-sectional transformation to different colors as well as the advertising effect of an evenly display by using an elongated housing on a bottom penholder.

In order to achieve said objectives, this invention consists essentially of a top penholder, a bottom penholder, and a conjoint part, wherein, a push bottom and a display illuminated mechanism are installed inside the top penholder, further including at least a battery, a spring, a circuit board, and at least a LED. The push button, which controls the circuit board, makes the LED illuminated. The bottom penholder connects with the top penholder by the conjoint part, followed by removing at least a part of a layer material coated on the bottom penholder forming at least a blank part. When the LED illuminates, the light emits towards the blank part of the bottom penholder to obtain certain advertising effect.

To enable a further understanding of the said objectives as well as other objectives, and structure details of the invention herein, the detailed description of the invention applications along with the brief description of drawings below shall provide additional elaboration.

### BRIEF DESCRIPTION OF THE DRAWINGS

FIG. 1 is a perspective view of a conventional advertising pen.

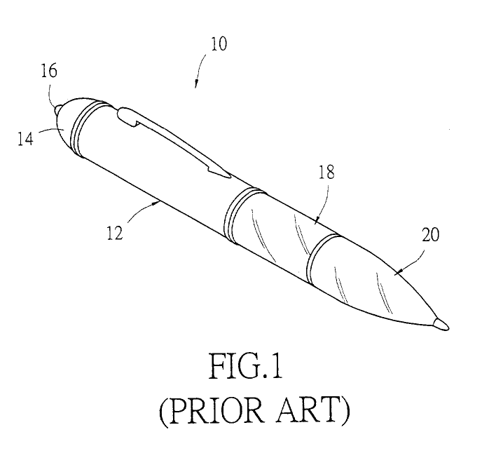

FIG. 2 is a perspective exploded view of a conventional advertising pen.

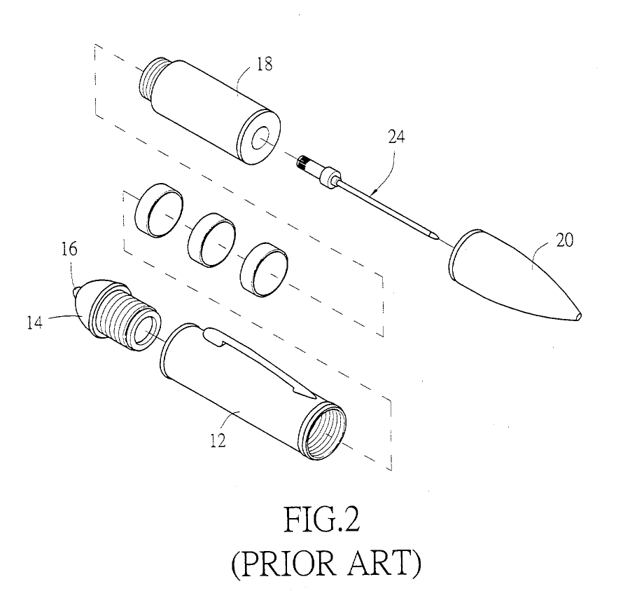

FIG. 3 is a perspective view of the present invention.

FIG. 4 is a perspective exploded view of the present invention.

FIG. 5 is a partial cross-sectional of the present invention.

FIG. 6 is a perspective view of a preferred embodiment of the present invention.

### DESCRIPTION OF THE PREFERRED EMBODIMENTS

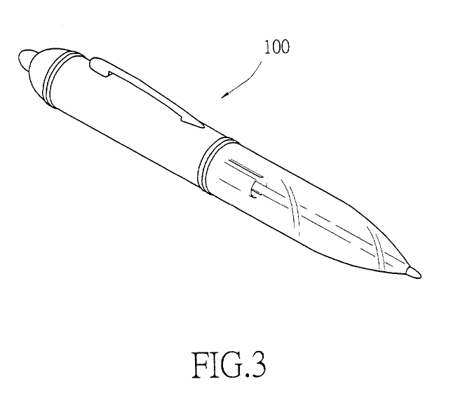

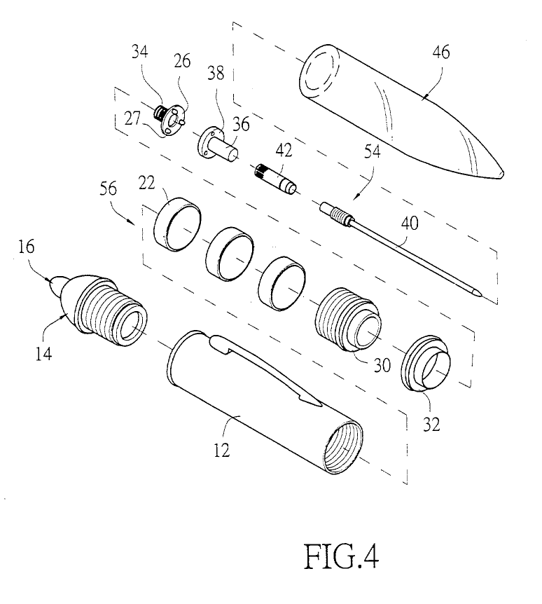

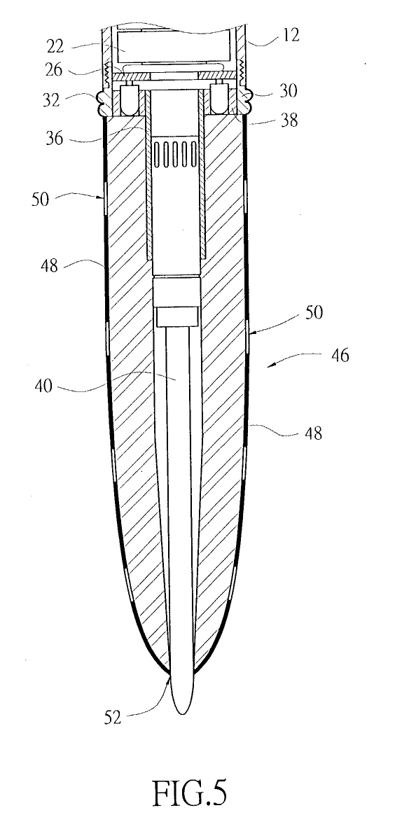

Referring to FIG. 3 and FIG. 4, a perspective view and a perspective exploded view of the present invention, which relates to an advertising-effect display pen structure, consists of a top penholder 12, a bottom penholder 24, and a conjoint part 30, wherein a push bottom 16 and a display illuminated mechanism 56 are installed inside the top having penholder 12 having at least a battery 22, a spring 34, a circuit board 26, and at least a LED 27. The push button 16 controling the circuit board 26 enables the LED 27 illuminated; the bottom penholder 46 connects with the top penholder 12 in a conjoint part 30, followed by removing at least a part of a layer material 48 (referring to FIG. 5) coated on the bottom penholder to make a blank part 50. When the LED 27 is illminated, the light emits towards the blank part 50 of the bottom penholder 46 thereon to obtain certain advertising effect.

Wherein, the circuit board 26 is by the design of a round sheet, which is implemented inside the conjoint part 30, to obtain a multi-sectional illuminating effect controlled by circuits or components mounted thereon. However, the multi-sectional illuminating technique is a well-known art, and thus not explained herein. Furthermore, a push bottom 16 is implemented on an upper end of the penhead 14 connecting to the top penholder 12 through the display illuminated mechanism 56.

Referring to FIG. 5, a partial perspective cross-sectional view of this invention, in addition to the display illuminated mechanism 56 has an advertising effect, a pen 100 itself also can provide a writing effect, which consists of a retractive mechanism 54, having at least an ink cartridge 40, a locking part 42, and a connective part 36. When the locking part 42 rotates thereby initiating the ink cartridge 40 to protrude outwardly or lock inwardly to a chamber 52. What needs to be explained particularly is, except having a plurality of LED 27 with the lighting display effect of a multi-sectional transformation in different colors, this invention also comprises an elongated housing on the bottom penholder 46 which allows the light emit directly through the chamber 46 of the bottom penholder 46 to create an advertising display effect. The elongated housing resolves the problem of the multi-sectional design on the penholder and the penpoint part, which is to make an advertisment dimension not to be restricted, and the light would not be blocked out to reach the penpoint part because of the LED installation.

Also worthy of mention, the LED 27 at least consists of a pen bottom 46, which material is plastic, acrylic, or glass; a conjoint part 30, and a bottom penholder 46; the conjoint part 30 can lock the top penholder 12 and the bottom penholder 46 together by the way of threading. Wherein, the conjoint part 30 further includes an incrustation 32 in order to block the light.

Also, a layer material 48 is a common material of plating or coating, which allows appointed LOGO, advertising characters, symbols, etc to be stamped, etched, or coated on the bottom penholder 46.

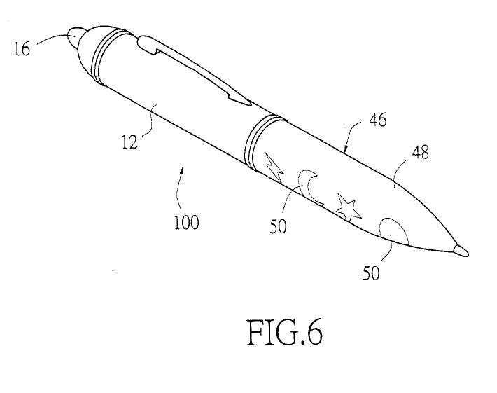

Referring to FIG. 6, a perspective view of a preferred embodiment of the present invention, through an elongated housing on the bottom penholder 46 is designed thereby widening the dimension and range of the advertising effect.

In summation of the foregoing sections, the present invention is explained with a practical assembly. It is of course to be understood that the embodiments described herein are merely illustrative of the principles of the invention and a wide variety of modifications thereto may be effected by persons skilled in the art without departing from the spirit and scope of the invention as set forth in the following claims.

1. An advertising-effect display pen comprising a top penholder, a bottom penholder, and a conjoint part, wherein a push bottom and a display illuminated mechanism are installed inside the top penholder, having at least a battery, a spring, a circuit board, and at least a LED; the push button controls the circuit board making the LED illuminated; the bottom penholder connects with the upper penholder by the conjoint part, followed by removing at least a part of a layer material coated on the bottom penholder, the light emits towards the bottom penholder and the blank part being removed the material displays the emission of the light and obtains certain advertising effect as the LED illuminates.

2. The advertising-effect display pen structure in accordance with claim 1, wherein, the circuit board is by the design of a round sheet, which is implemented inside the conjoint part 30 by the circuits or components mounted on the circuit board in order to obtain the lighting effect of a multi-sectional transformation.

3. The advertising-effect display pen structure in accordance with claim 1, wherein, the push bottom is implemented on the penhead connected to the top penholder.

4. The advertising-effect display pen structure in accordance with claim 1, wherein, there are three LEDs.

5. The advertising-effect display pen structure in accordance with claim 1, wherein, the ink cartridge is locked inside a chamber of the bottom penholder through a retractive mechanism, having at least an ink cartridge, a locking part, and a connective part; when the locking part rotates thereby initiating the ink cartridge to move downwards for protruding and move upwards for locking.

6. The advertising-effect display pen structure in accordance with claim 1, wherein, the material for the pen bottom is plastic, acrylic, or glass.

7. The advertising-effect display pen structure in accordance with claim 1, wherein, the conjoint part 30 locks the top penholder and the bottom penholder together by the way of threading.

8. The advertising-effect display pen structure in accordance with claim 1, wherein, the conjoint part further includes an incrustation.
